(19) United States
(12) Patent Application Publication
(10) Pub. No.: US 2026/0273385 A1
(43) Pub. Date: Sep. 17, 2026

(54) APPARATUS FOR REMOVING LOTTERY TICKET COATINGS

(71) Applicant: Kevin Kunselman, Beaver Falls, PA (US)

(72) Inventor: Kevin Kunselman, Beaver Falls, PA (US)

(21) Appl. No.: 19/077,756

(22) Filed: Mar. 12, 2025

(51) Int. Cl. A63F 3/06; B08B 1/10; B08B 1/30

(52) U.S. Cl. CPC A63F 3/068; B08B 1/10; B08B 1/30

(57) ABSTRACT

A removal and collection apparatus for removing a scratch-off release coating from a lottery ticket or similar card and collecting resultant particles includes a base and a platform mounted to the base, the base defines a chamber at one end of the platform for collecting scratch-off release coating particles. A removal member is slidably mounted to the base such that the removal member may slide across a lottery ticket positioned on the platform to remove a scratch-off release coating therefrom via abrasion, scraping, or similar processes. Troughs may be defined on opposing lateral sides of the platform for allowing scratch-off release coating particles to fall laterally off of the platform, and sweeping members may be positioned in the troughs to sweep such particles into the chamber.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to material removal and collection apparatuses and more particularly pertains to a new material removal and collection apparatus for removing a scratch-off release coating from a lottery ticket or similar card and collecting resultant particles.

### (2) Description of Related Art Including Information Disclosed Under 37 CFR 1.97 and 1.98

It can be time-consuming and messy to remove scratch-off release coatings from lottery tickets or other cards. The prior art provides several apparatuses which hold such items and collect shavings or particles of the scratch-off release coating in an enclosure after removal using typical scratching or abrading techniques and devices. However, such devices do not provide a means to simultaneously removal all scratch-off release coating of these cards in a single removal action which does not require repositioning of a removal tool. These devices also do not include a structure which allows for excess particles to fall off the card in a direction lateral to a direction of motion of such a removal tool. These improvements are needed in the art to facilitate removal of scratch-off release coatings more quickly and with less mess.

### (h) BRIEF SUMMARY OF THE INVENTION

An embodiment of the disclosure meets the needs presented above by generally comprising a base with a bottom wall, a pair of lateral walls, and an end wall. The bottom wall extends between the pair of lateral walls, and the end wall extends between the pair of lateral walls and upwardly from the bottom wall. A platform is mounted to the bottom wall of the base and has an upper surface which faces away from the bottom wall of the base for supporting the card thereon. A chamber for containing removed scratch-off release coating particles is defined between the pair of lateral walls of the base and between the end wall of the base and the platform. A removal member is slidably mounted to the base and is slidable across the upper surface of the platform alternately toward and away from the chamber. The removal member extends across a full width of the upper surface of the platform between a pair of lateral edges of the upper surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a removal and collection apparatus according to an embodiment of the disclosure.

FIG. 2 is a top in-use view of an embodiment of the disclosure.

FIG. 3 is an exploded end view of an embodiment of the disclosure.

FIG. 4 is a side view of an embodiment of the disclosure.

FIG. 5 is a cross-sectional view of an embodiment of the disclosure taken from Line 5-5 in FIG. 4.

### (j) DETAILED DESCRIPTION OF THE INVENTION

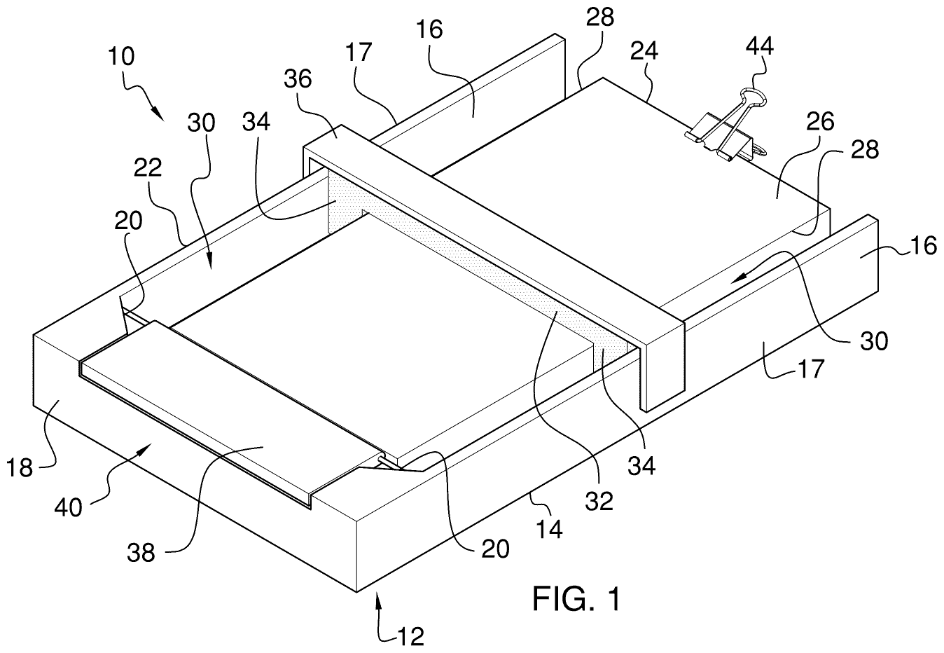

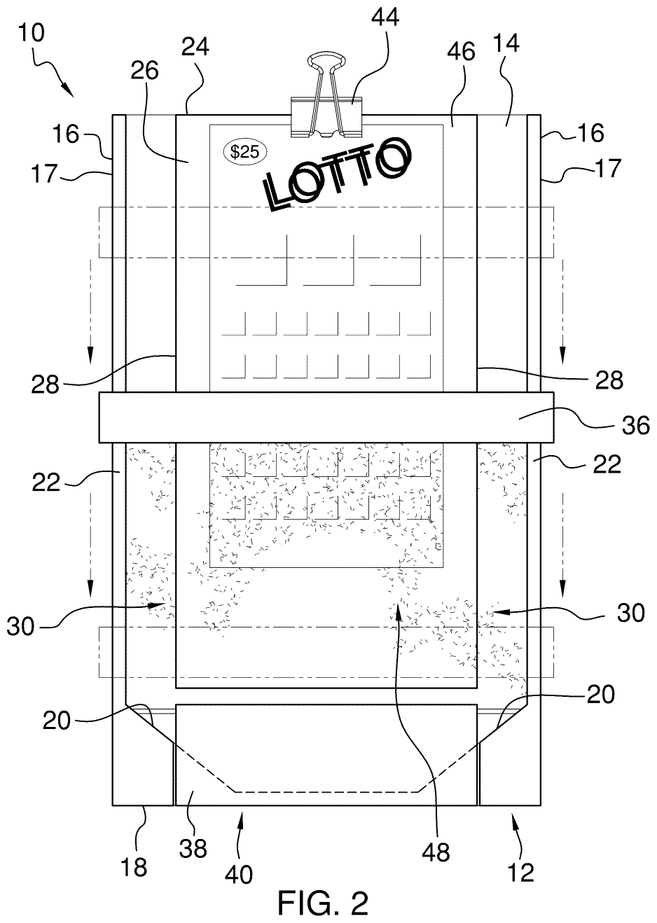

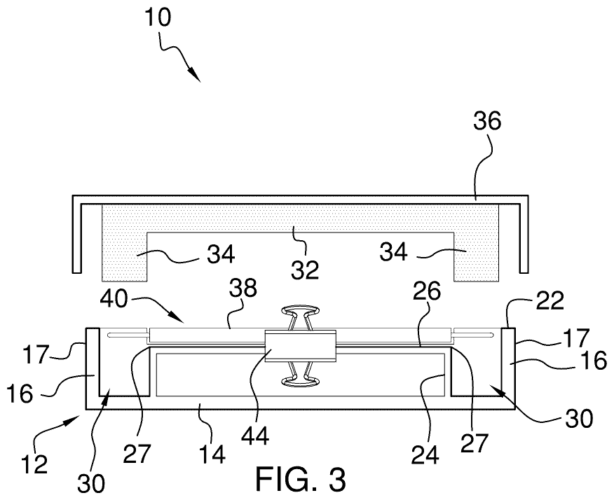

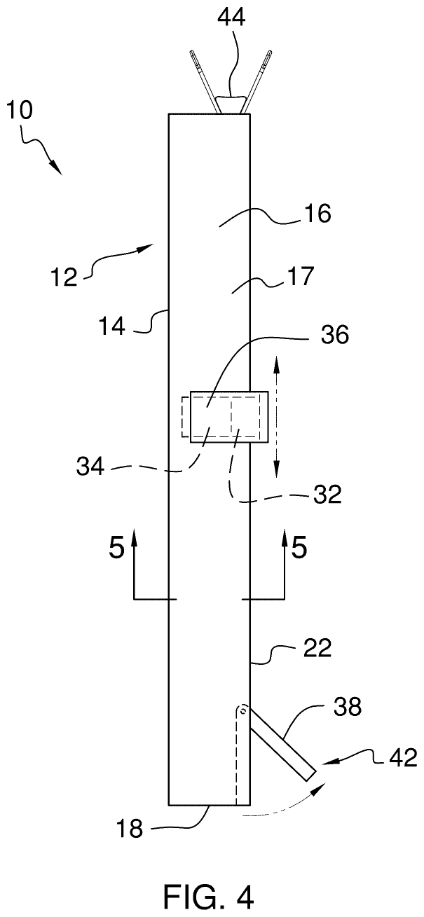

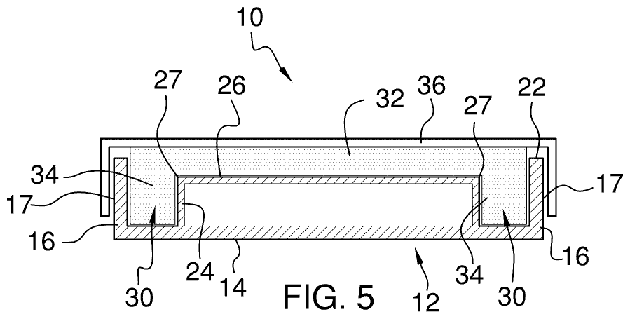

With reference now to the drawings, and in particular to FIGS. 1 through 5 thereof, a new material removal and collection apparatus embodying the principles and concepts of an embodiment of the disclosure and generally designated by the reference numeral 10 will be described.

As best illustrated in FIGS. 1 through 5, the removal and collection apparatus 10 generally comprises a base 12 which has a bottom wall 14, a pair of lateral walls 16, and an end wall 18. The bottom wall 14 extends between the pair of lateral walls 16, and the end wall 18 extends between the pair of lateral walls 16 and upwardly from the bottom wall 14. A platform 24 is mounted to the bottom wall 14 of the base 12 and has an upper surface 26 which faces away from the bottom wall 14 of the base 12. The platform 24 and the base 12 may be integrally formed with each other to define a monolithic structure. A card 46 having a scratch-off release coating (e.g., a lottery scratch-off ticket) may be positioned on the upper surface 26 of the platform 24.

A chamber 28 for containing removed scratch-off release coating particles 48 is defined between the pair of lateral walls 16 of the base 12 and between the end wall 18 of the base 12 and the platform 24. The chamber 28 is open at the top side 22 of the base 12, and an access door 38 is positioned to selectively provide access to the chamber 28 through the top side 22 of the base 12. The base 12 has a pair of guide surfaces 20, each of which is coupled to an associated lateral wall 16 of the pair of lateral walls 16 of the base 12 and is angled to extend inwardly from the associated lateral wall 16 and toward the end wall 18 of the base 12. The base 12 has a pair of troughs 30, each of which is defined between the platform 24 and an associated lateral wall 16 of the pair of lateral walls 16. Each trough 30 is in fluid communication with the chamber 28.

Scratch-off release coating particles 48 which are formed during removal from the card 46 may be swept over the card 46 into the chamber 28. Scratch-off release coating particles 48 which fall into the troughs 30 may also be swept into the chamber 28. Some of the scratch-off release coating particles 48, particularly those that fall into the troughs 30, may be directed by the guide surfaces 20 of the base 12 inwardly such that a compact pile is formed adjacent to the access door 38.

A removal member 32 is slidably mounted to the base 12. The removal member 32 is slidable across the upper surface 26 of the platform 24 alternately toward and away from the chamber 28. The removal member 32 extends across a full width of the upper surface 26 of the platform 24 between a pair of lateral edges 27 of the upper surface 26. The removal member 32 comprises a polymer foam but may comprise any material suitable for removing the scratch-off release coating from the card 46. For example, the removal member 32 may comprise a brush, a sandpaper, a scraper, or the like. Whichever material is selected for the removal member 32 must be sufficiently rough, hard, sharp, or otherwise suited to remove the scratch-off release coating from the card 46.

A pair of sweeping members 34 is coupled to the removal member 32, wherein each sweeping member 34 is positioned in an associated trough 30 of the pair of troughs 30. The sweeping members 34 slide along the associated troughs 30 when the removal member 32 slides across the card 46 over the platform 24. The sweeping members 34 are integrally formed with the removal member 32 but may be separately formed and comprise separate material types in other embodiments.

A slider bar 36 slidably mounts the removal member 32 and the sweeping members 34 to the base 12. The slider bar 36 is coupled to the removal member 32 and has a U-shape which extends over the top side 22 of the base 12 and exterior sides 17 of the pair of lateral walls 16 of the base 12. The removal member 32 is positioned within the U-shape such that the slider bar 36 is positioned opposite the card 46 across the removal member 32 during use. The slider bar 36 is spaced above the top side 22 of the base 12 when the removal member 32 is at rest atop the platform 24.

The polymer foam of the removal member 32 is resiliently compressible, and the slider bar 36 comprises a rigid material. As such, the slider bar 36 may be firmly gripped and may have a stable sliding contact with the exterior sides 17 of the lateral walls 16 which is unaffected by compression of the slider bar 36. Meanwhile, the slider bar 36 may be pressed downwardly against the card 46 over the platform 24 to urge the polymer foam of the removal member 32 against the card 46, which thereby compresses such that friction is enhanced between the removal member 32 and the card 46. The spacing of the slider bar 36 from the base 12 facilitates such compression.

The removal member 32, the sweeping members 34, and the slider bar 36 are removable from the base 12 via pulling the same upwardly away from the base 12 or by sliding the same away from the end wall 18 of the base 12 through an opposite end of the base 12. In some embodiments, the slider bar 36 may be secured to the base 12 via attachment to one or more tracks that run generally between the end wall 18 and the opposite end.

The access door 38 is movable between a closed position 40 and an open position 42 with respect to the chamber 28, wherein the access door 38 covers the chamber 28 at the top side 22 of the base 12 when in the closed position 40 and does not cover the chamber 28 at the top side 22 of the base 12 when in the open position 42. The access door 38 is pivotably mounted to the pair of lateral walls 16 of the base 12. In other embodiments, the access door 38 may be slidably mounted, to the base 12, removably mounted to the base 12, or otherwise movable between the closed position 40 and the open position 42.

A securement device 44 if provided for securing the card 46 to the platform 24. The securement device 44 comprises a clip which is biased to clamp shut. The clip is configured to clamp the card 46 onto the upper surface 26 of the platform 24. The clip comprises a binder clip but may comprise any suitable clip in other embodiments, including clips in which the platform 24 defines one of a pair of jaws of the clip. In other embodiments, the securement device 44 may comprise a weight, an adhesive, or another suitable fastening means.

In use, the card 46 is positioned on the upper surface 26 of the platform 24 and secured thereon via the securement device 44. The removal member 32 is abrasively urged along the card 46 to remove the scratch-off release coating and sweep the resultant scratch-off release coating particles 48 into the chamber 28. The sweeping members 34 are also moved to sweep some scratch-off release coating particles 48 which land in the troughs 30 into the chamber 28.

The base 12 may be positioned in a number of orientations during use which are advantageous to the removal of the scratch-off release coating. For example, the bottom wall 14 of the base 12 may rest atop a support surface such that a user may lean into the removal member 32 in an effort to apply more friction on the scratch-off release coating. The support surface supports the base 12 during such a process. To more effectively sweep scratch-off release coating particles 48 into the chamber 28, the base 12 may be oriented with the end wall 18 being positioned generally below the platform 24 and the troughs 30. Finally, tipping the base 12 so that the top side 22 of the base 12 faces generally downwardly may facilitate dumping the scratch-off release coating particles 48 which were collected in the chamber 28.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A removal and collection apparatus for removing a scratch-off release coating from a card, the removal and collection apparatus comprising:
a base, the base comprising a bottom wall, a pair of lateral walls, and an end wall, the bottom wall extending between the pair of lateral walls, the end wall extending between the pair of lateral walls and upwardly from the bottom wall;
a platform mounted to the bottom wall of the base, the platform having an upper surface facing away from the bottom wall of the base for supporting the card thereon;
wherein a chamber for containing removed scratch-off release coating particles is defined between the pair of lateral walls of the base and between the end wall of the base and the platform; and
a removal member slidably mounted to the base, the removal member being slidable across the upper surface of the platform alternately toward and away from the chamber, the removal member extending across a full width of the upper surface of the platform between a pair of lateral edges of the upper surface.

2. The removal and collection apparatus of claim 1, wherein the upper surface of the base is positioned between the bottom wall and a top side of the base.

3. The removal and collection apparatus of claim 1, wherein the chamber is open at the top side of the base, further comprising an access door mounted to the base, the access door being movable between a closed position and an open position with respect to the chamber, the access door covering the chamber at the top side of the base when in the closed position, the access door not covering the chamber at the top side of the base when in the open position.

4. The removal and collection apparatus of claim 3, wherein the access door is pivotably mounted to the pair of lateral walls of the base.

5. The removal and collection apparatus of claim 1, wherein the base has a pair of guide surfaces, each guide surface of the pair of guide surfaces being coupled to an associated lateral wall of the pair of lateral walls of the base, each guide surface of the pair of guide surfaces being angled to extend inwardly from the associated lateral wall and toward the end wall of the base.

6. The removal and collection apparatus of claim 1, wherein the removal member is removable from the base.

7. The removal and collection apparatus of claim 1, wherein a pair of troughs is defined between the platform and the pair of lateral walls, each trough of the pair of troughs being positioned between an associated lateral wall of the pair of lateral walls and the platform, each trough of the pair of troughs being in fluid communication with the chamber.

8. The removal and collection apparatus of claim 7, further comprising a pair of sweeping members coupled to the removal member, each sweeping member of the pair of sweeping members being positioned in an associated trough of the pair of troughs.

9. The removal and collection apparatus of claim 8, wherein the pair of sweeping members is integrally formed with the removal member.

10. The removal and collection apparatus of claim 1, further comprising a slider bar slidably mounting the removal member to the base, the slider bar being coupled to the removal member, the slider bar having a U-shape which extends over the top side of the base and exterior sides of the pair of lateral walls of the base.

11. The removal and collection apparatus of claim 10, wherein the slider bar is spaced above the top side of the base when the removal member is at rest atop the platform, the removal member being resiliently compressible, the slider bar comprising a rigid material.

12. The removal and collection apparatus of claim 1, further comprising a securement device configured to secure the card to the platform.

13. The removal and collection apparatus of claim 12, wherein the securement device comprises a clip which is biased to clamp shut, the clip being configured to clamp the card onto the upper surface of the platform.

14. A removal and collection apparatus for removing a scratch-off release coating from a card, the removal and collection apparatus comprising:
a base, the base comprising a bottom wall, a pair of lateral walls, and an end wall, the bottom wall extending between the pair of lateral walls, the end wall extending between the pair of lateral walls and upwardly from the bottom wall;
a platform mounted to the bottom wall of the base, the platform having an upper surface facing away from the bottom wall of the base for supporting the card thereon;
wherein a chamber for containing removed scratch-off release coating particles is defined between the pair of lateral walls of the base and between the end wall of the base and the platform, the chamber being open at the top side of the base, the base having a pair of guide surfaces, each guide surface of the pair of guide surfaces being coupled to an associated lateral wall of the pair of lateral walls of the base, each guide surface of the pair of guide surfaces being angled to extend inwardly from the associated lateral wall and toward the end wall of the base;
a removal member slidably mounted to the base, the removal member being slidable across the upper surface of the platform alternately toward and away from the chamber, the removal member extending across a full width of the upper surface of the platform between a pair of lateral edges of the upper surface, the removal member being removable from the base;
wherein a pair of troughs is defined between the platform and the pair of lateral walls, each trough of the pair of troughs being positioned between an associated lateral wall of the pair of lateral walls and the platform, each trough of the pair of troughs being in fluid communication with the chamber;
a pair of sweeping members coupled to the removal member, each sweeping member of the pair of sweeping members being positioned in an associated trough of the pair of troughs, the pair of sweeping members being integrally formed with the removal member;
a slider bar slidably mounting the removal member to the base, the slider bar being coupled to the removal member, the slider bar having a U-shape which extends over the top side of the base and exterior sides of the pair of lateral walls of the base, the slider bar being spaced above the top side of the base when the removal member is at rest atop the platform, the removal member being resiliently compressible, the slider bar comprising a rigid material;
an access door mounted to the base, the access door being movable between a closed position and an open position with respect to the chamber, the access door covering the chamber at the top side of the base when in the closed position, the access door not covering the chamber at the top side of the base when in the open position, the access door being pivotably mounted to the pair of lateral walls of the base; and
a securement device for securing the card to the platform, the securement device comprising a clip which is biased to clamp shut, the clip being configured to clamp the card onto the upper surface of the platform.
